(19) United States
(12) Patent Application Publication
(10) Pub. No.: US 2014/0074807 A1
(43) Pub. Date: Mar. 13, 2014

(54) System and Method for Providing Version Management Services Within a Collaborative Content Editing Environment

(71) Applicants: Yana Kane-Esrig, Madison, NJ (US); Michael J. Burns, Middletown, NJ (US)

(72) Inventors: Yana Kane-Esrig, Madison, NJ (US); Michael J. Burns, Middletown, NJ (US)

(73) Assignee: ALCATEL-LUCENT USA INC., Murray Hill, NJ (US)

(21) Appl. No.: 13/614,152

(22) Filed: Sep. 13, 2012

(51) Int. Cl. G06F 17/30

(52) U.S. Cl. CPC G06F 17/30371
USPC 707/695

(57) ABSTRACT

A plurality of versions of an object are stored in a memory. A plurality of votes relating to the plurality of versions are received from a plurality of parties. A version of the object is selected from among the plurality of versions, based on the plurality of votes. A second plurality of versions of the object are generated based on the selected version. Metadata associated with the selected version is stored, the metadata comprising first data specifying the plurality of parties from whom votes were received and second data specifying the votes received. In one embodiment, the object is an architectural design.

### TECHNICAL FIELD

This specification relates generally to systems and methods for managing versions in a content editing system, and more particularly to systems and methods for providing version management services within a collaborative content creation and editing environment.

### BACKGROUND

The process of creating digital content has become increasingly more collaborative and iterative. Today, multiple participants can access a design tool via the Internet and collaborate in editing a design in real-time. However, as technology has facilitated opportunities for collaboration, the tasks involved in monitoring various aspects of an evolving design in a collaborative environment have become increasingly complex. In many cases, participants in the creation and review process are in different locations and rely on digital communication tools for real-time collaboration. Keeping track of various versions created by various team members in different locations and at different times can be challenging. In addition, the members of a team working on digital content may change during the course of a design project; some participants may leave the team while new participants may join. In such circumstances, tracking responsibility and attribution for various elements of the design can be difficult.

### SUMMARY

In accordance with an embodiment, a plurality of versions of an object are stored in a memory. A plurality of votes relating to the plurality of versions are received from a plurality of parties. A version of the object is selected from among the plurality of versions, based on the plurality of votes. One or more versions of the object are generated based on the selected version. Metadata associated with the selected version is stored, wherein the metadata comprises first data specifying the plurality of parties from whom votes were received and second data specifying the votes received. In one embodiment, the object is an architectural design.

In one embodiment, access to the plurality of versions is provided via a network, and the plurality of votes are received via the network.

In another embodiment, a development history tree indicating relationships among the plurality of versions is generated, and an animation showing a chronological development of the plurality of versions is provided based on the development history tree.

In another embodiment, the metadata associated with the selected version further comprises third data specifying a plurality of elements associated with the selected version and fourth data specifying, for each respective element among the plurality of elements, a contributor who contributed to a design of the element.

In accordance with another embodiment, a plurality of versions of an object are stored, each respective version of the object comprising a plurality of elements. Metadata associated with each respective version among the plurality of versions is stored, wherein the metadata associated with a respective version comprises: first data specifying a plurality of parties who contributed to the version and, for each respective first element associated with the version, a first party who contributed to a creation of the first element, and second data specifying a second version from which the version was derived, a second plurality of parties who contributed to the second version and, for each respective second element associated with the second version, a second party who contributed to a creation of the second element. In one embodiment, the object is an architectural design.

In another embodiment, first metadata associated with a particular version is automatically generated, and second metadata associated with the particular version is determined based on input received from a user. The input may include one of: a cost estimate, a comment, and a name of a party who contributed to a creation of a particular element of the particular version. In one embodiment, access to the plurality of versions is provided via a network, and the input is received via the network.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to provide version management services in accordance with an embodiment;

FIG. 2 shows functional components of an exemplary user device in accordance with an embodiment;

FIG. 3 shows functional components of a content versioning system in accordance with an embodiment;

FIG. 4A shows a version of a design generated using the content versioning system of FIG. 3 in accordance with an embodiment;

FIG. 4B shows the version shown in FIG. 4A and a menu that includes a fix version option in accordance with an embodiment;

FIG. 5 is a flowchart of a method of storing data relating to versions of an object in accordance with an embodiment;

FIG. 6 shows a design project file in accordance with an embodiment;

FIGS. 7A-7C show metadata associated with various versions of an object in accordance with an embodiment;

FIG. 8 shows several development history trees in accordance with an embodiment;

FIG. 9 is a flowchart of a method of selecting a version of content based on votes received in accordance with an embodiment;

FIGS. 10A-10L shows various versions of an object in accordance with an embodiment;

FIG. 11 shows a version of an object and associated metadata displayed during an animation in accordance with an embodiment; and

FIG. 12 shows a computer that may be used to implement certain embodiments of the invention.

### DETAILED DESCRIPTION

FIG. 1 shows a communication system 100 that may be used to provide version management services, in accordance with an embodiment. Communication system 100 comprises a network 105, a content version system 130, user devices 160-A, 160-B, 160-C, 160-D, 160-E, etc., and stakeholder devices 170-A, 170-B, 170-C, etc.

For convenience, the term “user device 160” is used herein to refer to any one of user devices 160-A, 160-B, 160-C, 160-D, 160-E, etc. Accordingly, any discussion herein referring to “user device 160” is equally applicable to each of user devices 160-A, 160-B, 160-C, 160-D, 160-E, etc. While five user devices are shown in FIG. 1, communication system 100 may comprise any number of user devices.

For convenience, the term “stakeholder device 170” is used herein to refer to any one of stakeholder devices 170-A, 170-B, 170-C, etc. Accordingly, any discussion herein referring to “stakeholder device 160” is equally applicable to each of stakeholder devices 170-A, 170-B, 170-C, etc. While three stakeholder devices are shown in FIG. 1, communication system 100 may comprise any number of stakeholder devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

Content versioning system 130 provides content management services to users via network 105. For example, content versioning system 130 may allow one or more users to access a design tool via network 105 and create and edit content. Content versioning system 130 may store the user's content, and manage various versions of the content created by the user. Content versioning system 130 may be accessible via a World Wide Web page that may be viewed using a conventional Web browser, for example. A user may be required to log into a respective user account to access desired content or other data maintained by content versioning system 130.

User device 160 may be any device that enables a user to communicate via network 105. User device 160 may be connected to network 105 through a direct (wired) link, or wirelessly. User device 160 may have a display screen (not shown) for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

Stakeholder devices 170 may be any device that enables a stakeholder to communicate via network 105. Stakeholder device 170 may be connected to network 105 through a direct (wired) link, or wirelessly. Stakeholder device 170 may have a display screen (not shown) for displaying information. For example, stakeholder device 170 may be a personal computer, a laptop computer, a workstation, a mainframe computer, etc. Alternatively, stakeholder device 170 may be a mobile communication device such as a wireless phone, a personal digital assistant, etc. Other devices may be used.

As used herein, the term “user” signifies a person who accesses content versioning system 130 and directly participates in creating and editing content. The term “stakeholder” signifies a person who has “stakeholder” privileges (for example, the ability to vote on a design and/or provide specific types of metadata) but who is not one of the “users” of content versioning system 130 (i.e., who does not participate directly in creating and editing content).

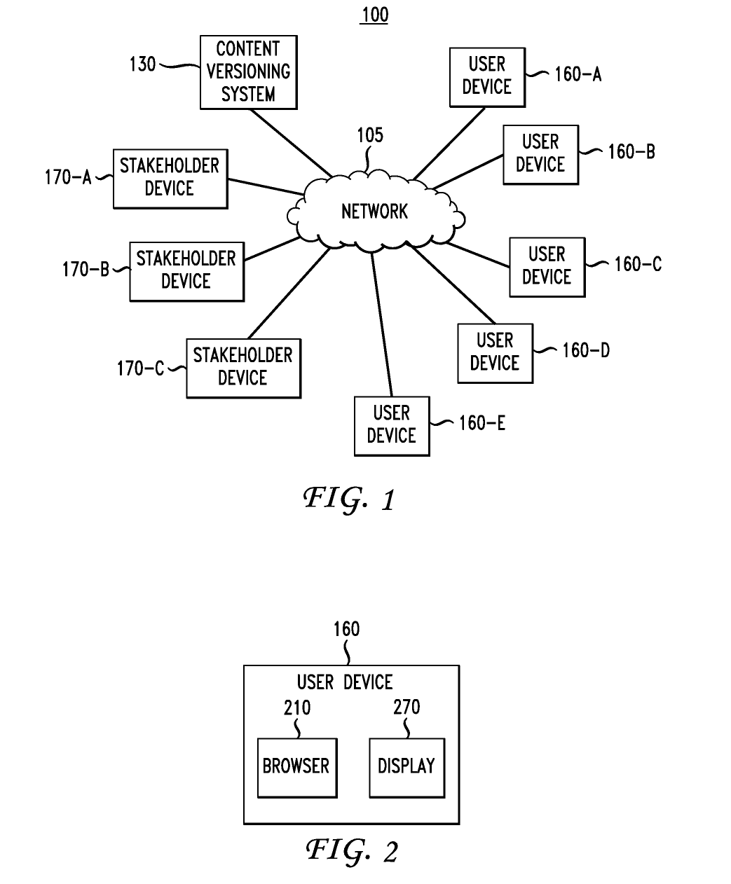

FIG. 2 shows functional components of an exemplary user device 160 in accordance with an embodiment. User device 160 comprises a web browser 210 and a display 270. Web browser 210 may be a conventional web browser used to access World Wide Web sites via the Internet, for example. Display 270 displays images, documents, Web pages, and other information to a user. For example, content that a user creates or edits may be displayed on display 270.

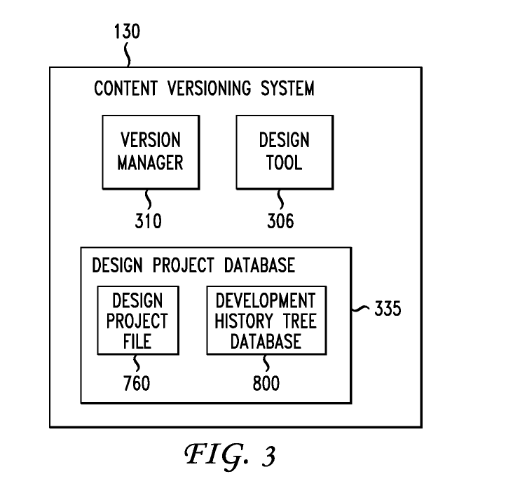

FIG. 3 shows functional components of content versioning system 130 in accordance with an embodiment. Content versioning system 130 comprises a design tool 306, a version manager 310, and a design project database 335. Design tool 306 allows users to design content. In an illustrative embodiment, design tool 306 is an architectural design tool that allows users to generate architectural designs and drawings. For example, design tool 306 may provide a whiteboard application that allows multiple users located in different locations to access the application and to draw or otherwise create designs and drawings, and that allows such designs and drawings to be visible to other users. The design tool may include graphical design elements to facilitate drawing geographical shapes, color the shapes, add text annotations, etc. In other embodiments, design tool 306 may provide functionality to allow users to produce and edit other types of content, such as text, numerical computations, musical compositions or scores, and other audio, video and/or other multimedia content. Version manager 310 keeps track of various versions of content that users are working on, and maintains information relating to the various versions. Design project database 335 comprises a memory in which content and related information may be stored.

In accordance with an embodiment, a plurality of users, or collaborators, may access content versioning system 130 from multiple user devices, via network 105, and collaborate in creating content. After the collaborators generate a first version of the content, they may subsequently edit the content and create additional versions of the content. The various versions of the content, and related information, are maintained by content versioning system 130.

Suppose, for example, that a group of designers are engaged by Client XYZ to produce a design for a particular project. In an illustrative embodiment, Client XYZ engages User A, User B, User C, User D, and User E to produce an architectural design in accordance with certain design requirements. Users A, B, C, D and E employ user devices 160-A, 160-B, 160-C, 160-D, and 160-E, respectively, to access content versioning system 130. In the illustrative embodiment, Users A, B and C are employees of Design Company 123 while Users D and E are independent contractors.

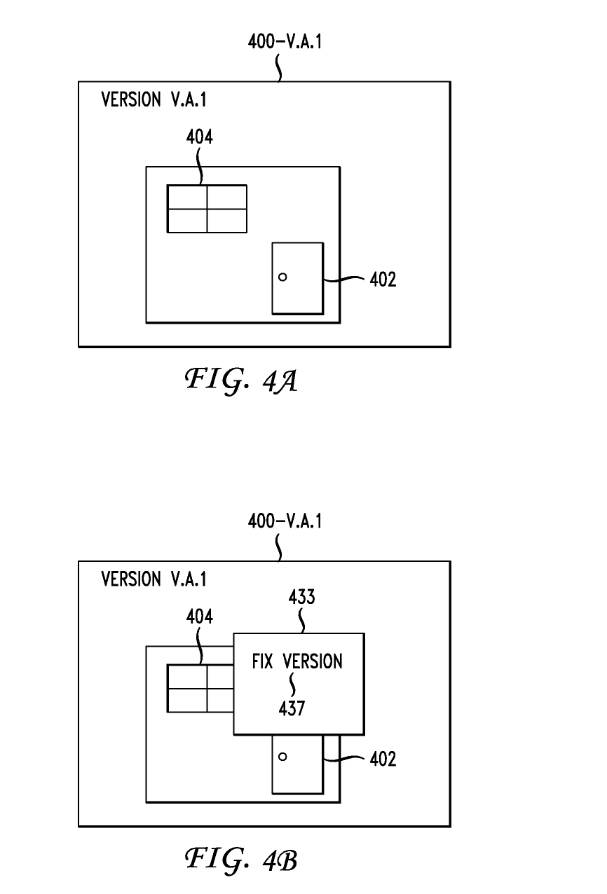

In the illustrative embodiment, User A and User B begin the first phase (Phase A) of the design process. On DATE-CC.1, User A and User B participate in a conference call and simultaneously employ user devices 160-A and 160-B to access content versioning system 130 via network 105. Users A and B and employ the whiteboard function provided by design tool 306 and generate a first version of the design, shown in FIG. 4A as design version 400-V.A.1. Design Version 400-V.A.1 comprises an initial design of a building that includes a door 402 and a window 404. User A designs door 402 and User B designs window 404.

Suppose now that Users A and B agree to “fix” version 400-V.A.1 as the designated “root” version for future alternative versions. In accordance with an embodiment, a user may “fix” a particular version of content by selecting an appropriate option. For example, while accessing Version 400-V.A.1, a user may right-click on a computer mouse to obtain a menu such as menu 433 shown in FIG. 4B. Menu 433 includes a Fix Version option 437. When the user selects Fix Version option 437, version manager 310 stores version 400-V.A.1 and may also store related metadata. In other embodiments, a particular version may be fixed using other techniques.

In one embodiment, a user may also select an option to designate a particular version as a root version from which other alternative versions will be derived. For example, a root option may be displayed on a menu on a user device 160. When the option is selected, version manager 310 designates the version as a root version. In the illustrative embodiment, the users designate version 400-V.A.1 as a root version.

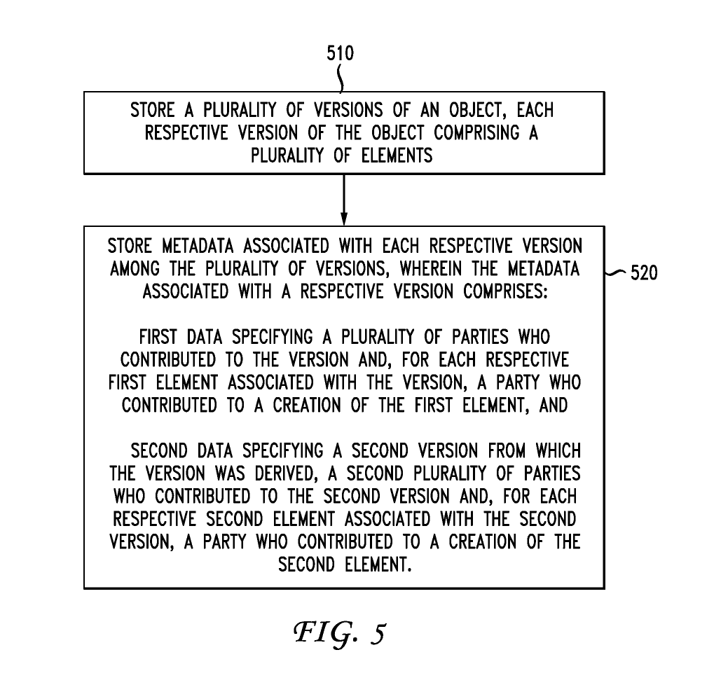

In one embodiment, when a version is fixed, the version and related metadata are stored in design project database 335. FIG. 5 is a flowchart of a method of storing data relating to various versions of an object in accordance with an embodiment. At step 510, a plurality of versions of an object are stored, each respective version of the object comprising a plurality of elements. At step 520, metadata associated with each respective version among the plurality of versions is stored, wherein the metadata associated with a respective version comprises: first data specifying a plurality of parties who contributed to the version and, for each respective first element associated with the version, a party who contributed to a creation of the first element, and second data specifying a second version from which the version was derived, a second plurality of parties who contributed to the second version and, for each respective second element associated with the second version, a party who contributed to a creation of the second element.

In this discussion, the term “object” includes any design, drawing, document, file, database contents, or other type of digital design or digital content that may be generated using design tool 306.

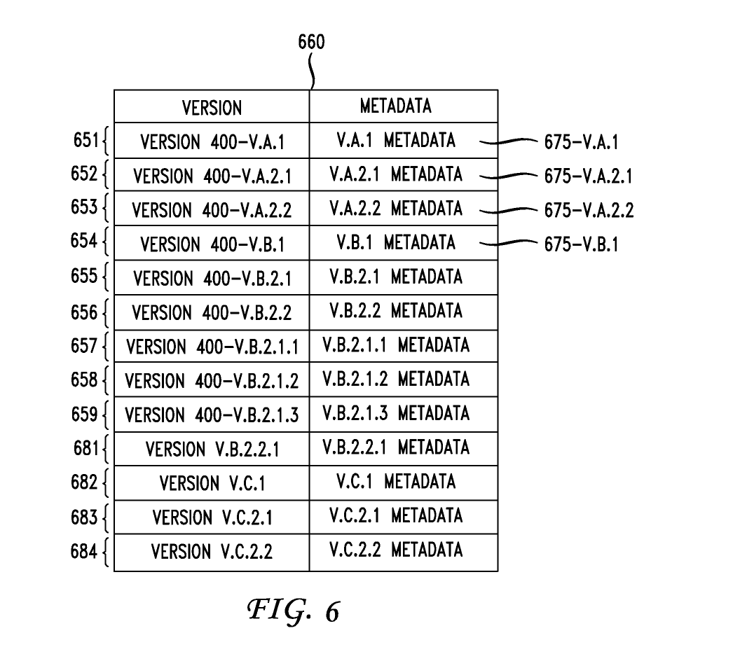

In the illustrative embodiment, version manager 310 stores version 400-V.A.1 in a design project file such as that shown in FIG. 6. Design project file 660 comprises a plurality of versions and metadata corresponding to each respective version. In this illustrative example, each record includes a respective version of the design and metadata associated with that respective version. For example, record 651 holds version 400-V.A.1. In other embodiments, data defining a version may be stored in multiple files. In another embodiment, data defining a version may be stored as data elements in a database.

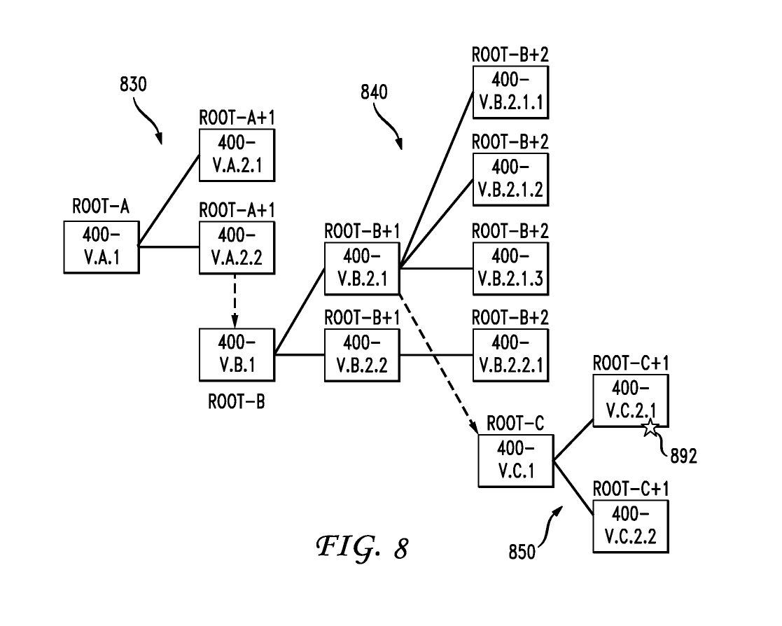

Version manager 310 also creates and maintains a development history tree associated with the design project. When a root version of content is created and fixed, version manager 310 creates a development history tree associated with the root version. Referring to FIG. 8, version manager 310 creates development history tree 830 associated with root version V.A.1. Development history tree 830 is stored in development history tree database 800, which is stored in design project database 335, as shown in FIG. 3. As alternative versions are generated based on the root version, the development tree is updated to reflect the alternative versions. Alternative versions derived from the root version are sometimes referred to herein as “leaf” versions of the development history tree. Accordingly, a development history tree reflects the chronological development of various related versions of a design or other object. A development history tree may have multiple levels at different “distances” from the root representing how many “generations” or iterations separate a particular version from the root version. A location on a development history tree may accordingly be referred to as “root,” “root+1,” “root+2,” etc. In other embodiments, a development history tree may be organized and presented in a different manner.

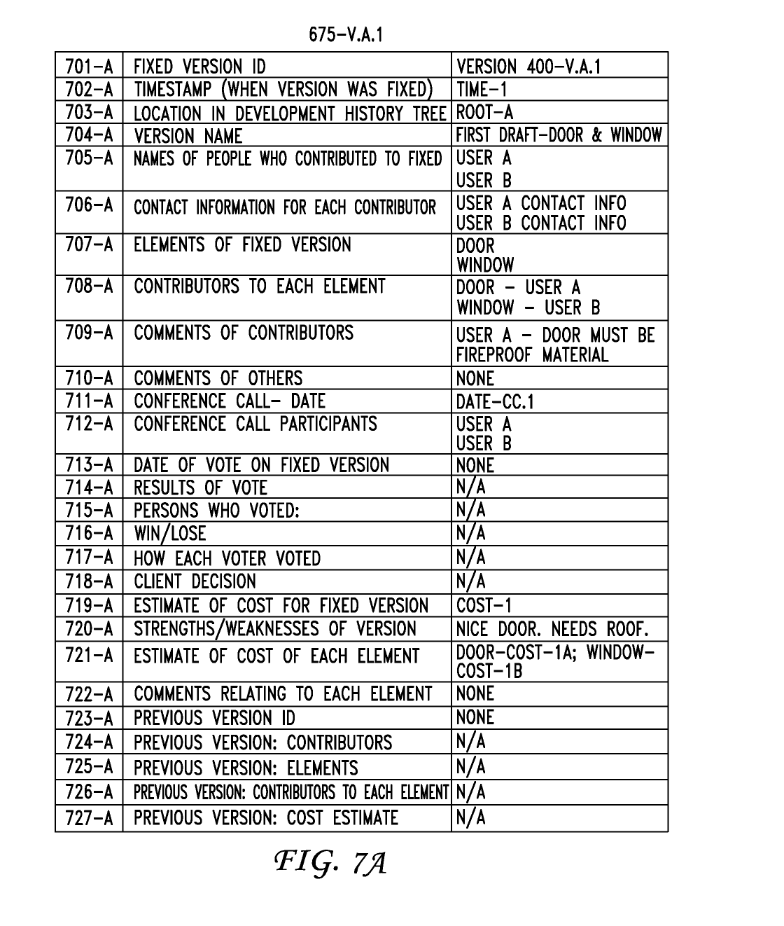

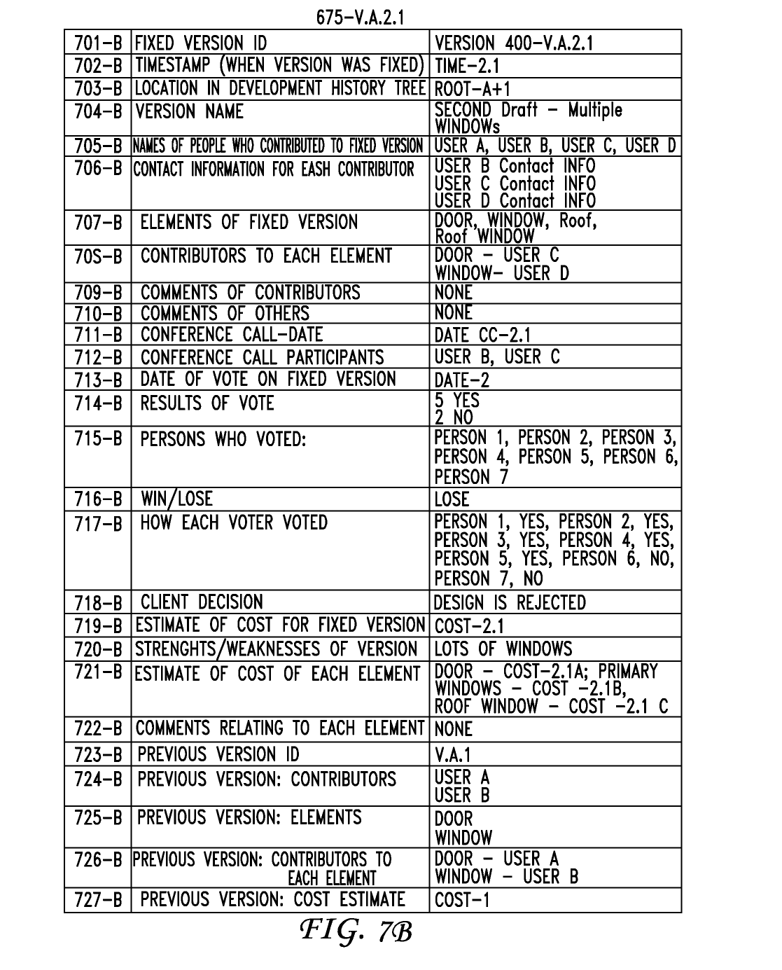

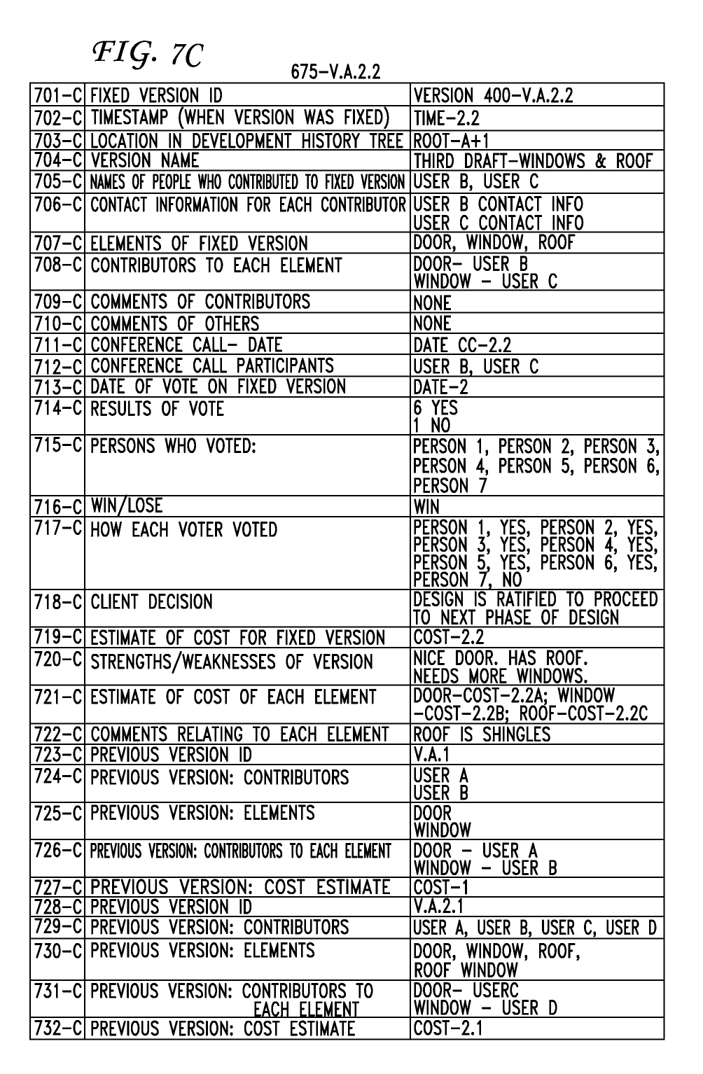

Referring again to FIG. 6, version manager 310 also stores in record 651 metadata 675-V.A.1 associated with version 400-V.A.1. FIG. 7A shows metadata 675-V.A.1 in accordance with an embodiment. The metadata shown in FIG. 7A is illustrative only. In other embodiments, other types of metadata may be stored in association with a version of an object, and metadata may be stored using different types of data structures than that shown.

Record 701-A holds a version identifier for Version 400-V.A.1. Record 702-A holds a timestamp specifying a date and time when the version was fixed. In this instance, Version 400-V.A.1 was fixed at TIME-1. In one embodiment, the version identifier stored in record 701-A and the timestamp stored in record 702-A are automatically generated when Version 400-V.A.1 is fixed.

Record 703-A specifies a location of version 400-V.A.1 in the corresponding development history tree. In this instance, record 703-A indicates ROOT-A, indicating that version 400-V.A.1 is at the root level of development history tree 830. Record 704-A specifies a version name, which is entered by a user. In the illustrative embodiment, record 704-A stores the name “First Draft—Door & Window.” Record 705-A stores names of users who contributed to the current fixed version. In this instance, User A and User B contributed to Version 400-V.A.1. Record 706-A holds contact information for the persons specified in record 705-A. Record 707-A stores information defining one or more elements of the design of the current version. In the illustrative embodiment of FIG. 7A, record 707-A indicates that Version 400-V.A.1 includes a door and a window. Record 708-A indicates one or more users who contributed to the design of each element specified in record 707-A. In this example, User A designed the door and User B designed the window. Record 709-A holds comments made by the contributors, if any. In the example of FIG. 7A, a comment by User A that the “door must be fireproof material” is stored in record 709-A. Record 710-A may hold comments by other persons, if any. In this example, no other comments are included.

Record 711-A stores information indicating when a conference call was held to discuss the current version. Record 712-A stores information identifying the participants on the conference call. In the illustrative embodiment, records 711-A and 712-A indicate that a conference call was held on DATE-CC.1 and was attended by User A and User B. The metadata in records 711-A and 712-A may be automatically generated when the version is fixed.

Records 713-A and 714-A may store information specifying a date when a vote was held on the fixed version, and the results of the vote. Record 715-A may specify the persons who voted. Record 716-A may indicate whether the current version won or lost the vote. Record 717-A may specify how each voter voted. The contents and use of records 713-A through 717-A are discussed in more detail below.

Record 718-A holds information indicating a client decision, if any, concerning the current version. In the illustrative example, no client decision was made concerning Version 400-V.A.1.

Record 719-A stores a cost estimate for the fixed version. A cost estimate may be entered manually by a user. In the illustrative embodiment, record 719-A indicates that the estimated cost of Version 400-V.A.1 is COST-1. Record 720-A may hold information relating to strengths and/or weaknesses of the current fixed version. In the illustrative embodiment, record 720-A contains the following information: “Nice Door. Needs Roof” Record 721-A stores information specifying an estimated cost of each element listed in record 707-A. In this example, record 721-A indicates that estimated cost of the door would be COST-1A and that the estimated cost of the window would be COST-1B. Record 722-A stores comments relating to one or more of the elements specified in record 707-A, if any.

In one embodiment, the metadata stored in records 719-A, 720-A, 721-A, and 722-A may be manually entered when Version 400-V.A.1 is fixed or at another time. In some embodiments, certain items of metadata may be automatically generated and stored. For example, the estimated cost of a particular version may be automatically calculated based on the cost estimates for each element associated with the version, and stored automatically in the appropriate record. In one embodiment, certain items of metadata may be modified after being entered and stored. In one embodiment, certain items of metadata are fixed upon being stored and may not be modified after being stored.

In one embodiment, authority to manually enter metadata, or to modify metadata, may be granted to an individual based on the individual's identity. For example, the right to manually enter metadata, and to modify metadata, may be granted only to members of the design team. Other stakeholders, including members of the client and other persons, are not granted such authority. In other embodiments, authority to manually enter metadata, or to modify metadata, may be granted based on other criteria.

Record 723-A may specify a version identifier of a previous version, if any. In the illustrative embodiment, version 400-V.A.1 is the root version for the project and there is no previous version; thus record 723-A specifies “None”. Similarly, records 724-A, 725-A, 726-A, and 727-A specify, respectively, contributors associated with the previous version, elements of the previous version, contributors to the respective elements of the previous version, and a cost estimate of the previous version. Because there are no previous versions, these records are empty. In another embodiment, a metadata file associated with a particular version includes one or more references (such as one or more pointers, for example) to each prior “ancestor” or related version, and one or more references to the metadata related to each such prior version.

In one embodiment, one or more items of the metadata associated with a version are automatically generated when the version is fixed by the user(s). For example, the version identifier stored in record 701-A may be automatically generated, the timestamp stored in record 702-A may be automatically generated, etc.

In another embodiment, one or more items of metadata associated with a particular version may be manually generated. For example, the cost estimate stored in record 719-A may be entered by the users. Similarly, users may manually enter the information in record 708-A attributing credit for various elements of the design to particular users.

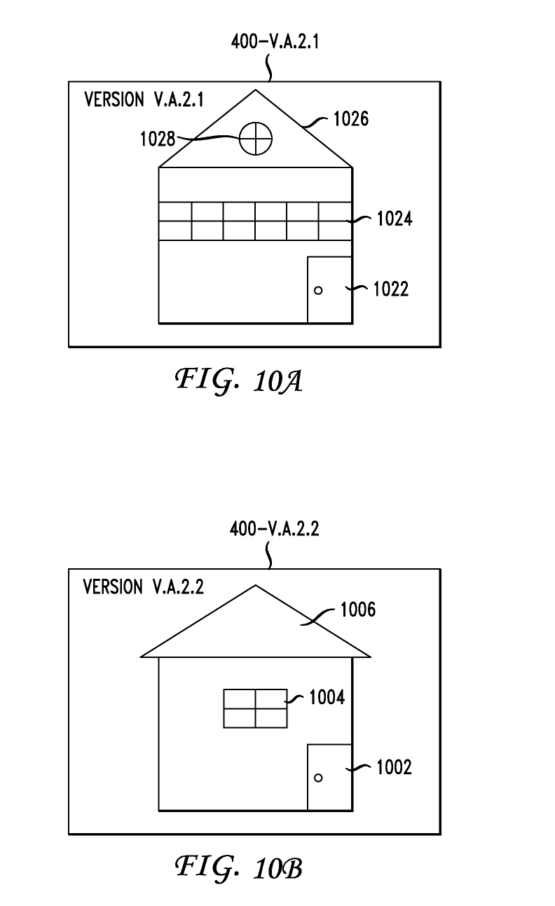

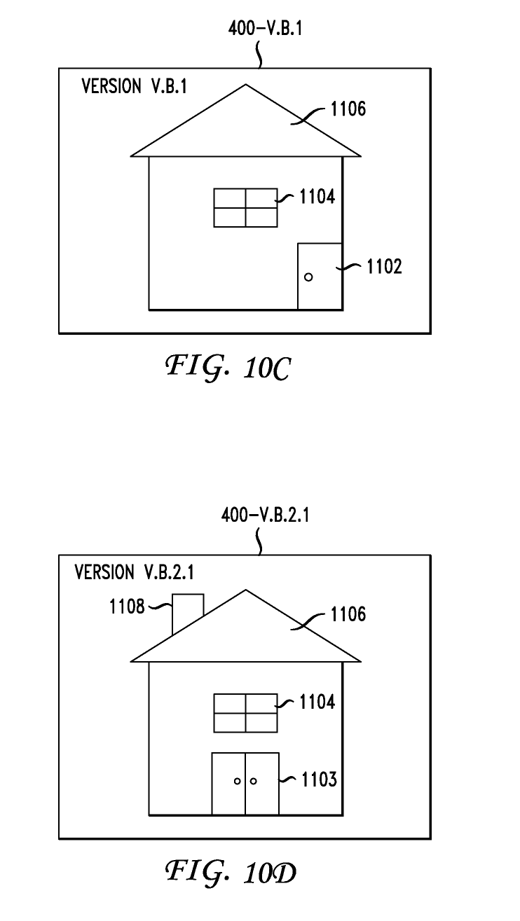

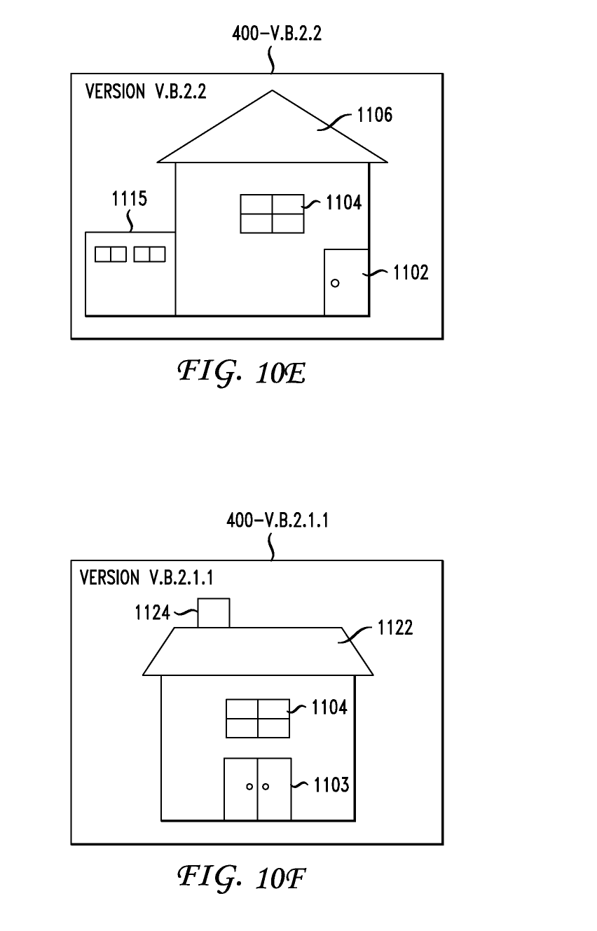

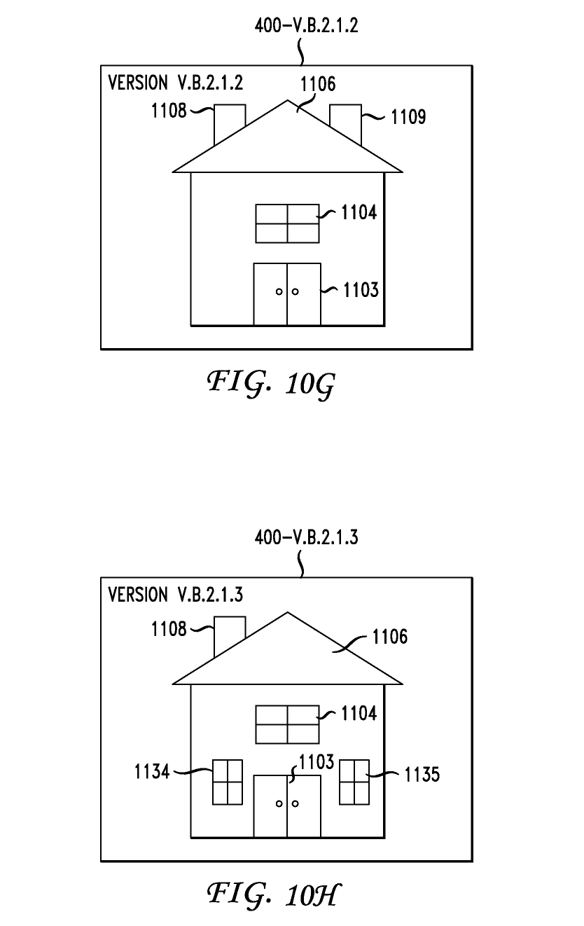

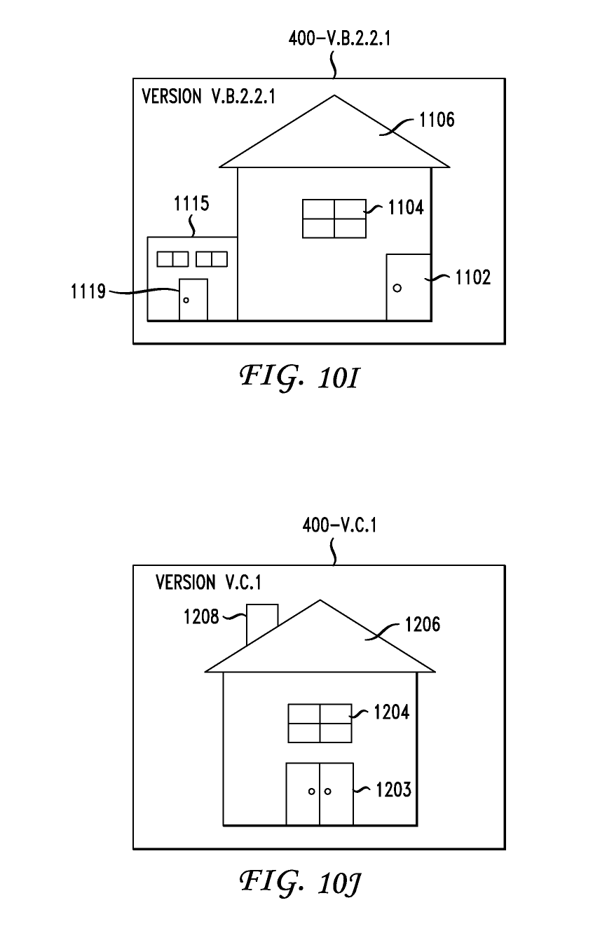

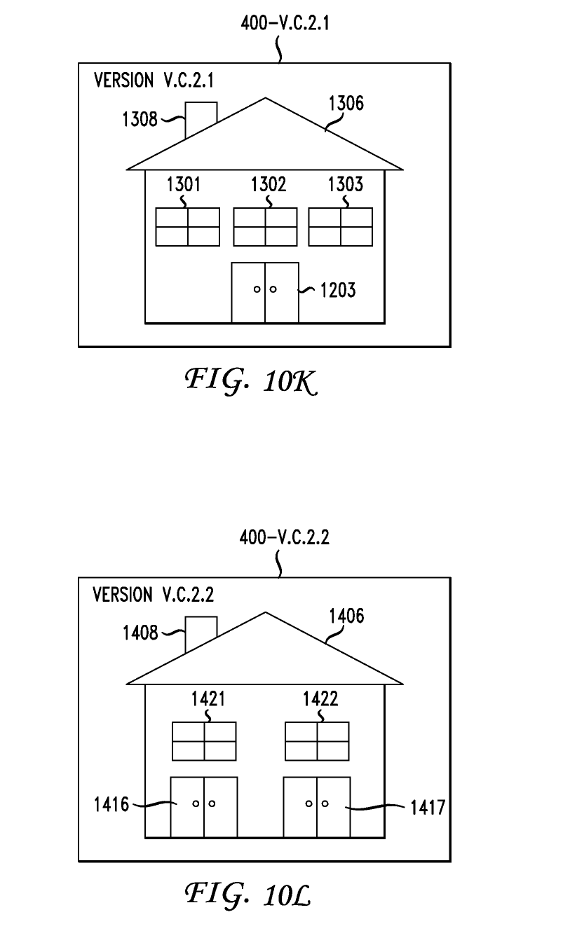

Suppose now that User B and User C start from Version 400-V.A.1 and elaborate upon the design to generate two alternative versions: a first version 400-V.A.2.1 shown in FIG. 10A, and a second version 400-V.A.2.2, shown in FIG. 10B. Version 400-V.A.2.1 comprises four elements: a door 1022, a first window, 1024, a roof 1026, and a second window 1028. Version 400-V.A.2.2 comprises three elements: a door 1002, a window 1004 and a roof 1006. User B and User C fix version 400-V.A.2.1 at TIME-2.1. Subsequently they fix version 400-V.A.2.2 at TIME-2.2. Suppose further that the contributors wish to present these versions to the client and request the client's input.

In accordance with an embodiment, a plurality of alternative versions of content may be displayed to a plurality of parties. A single version is selected from among the alternative versions and fixed, based on votes received from the plurality of parties.

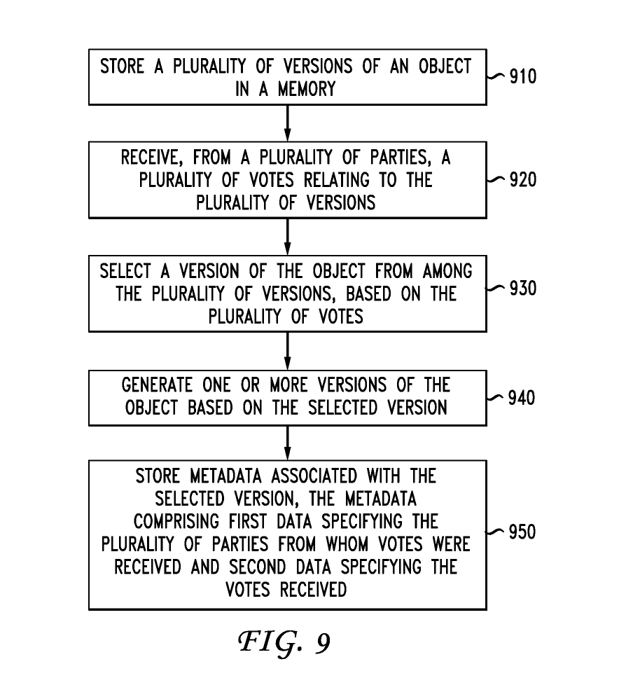

FIG. 9 is a flowchart of a method of selecting a version of content based on votes received in accordance with an embodiment. At step 910, a plurality of versions of an object are stored in a memory. When Version 400-V.A.2.1 is fixed, version manager 310 stores version 400-V.A.2.1 in record 652 of design project file 660, as shown in FIG. 6. In addition, version manager 310 stores metadata associated with version 400-V.A.2.1 in design project file 660. FIG. 7B shows metadata 675-V.A.2.1 associated with Version 400-V.A.2.1 in accordance with an embodiment. Metadata 675-V.A.2.1 is discussed below.

Version manager 310 also stores version 400-V.A.2.2 in record 653 of design project file 660, as shown in FIG. 6. In addition, version manager 310 stores metadata associated with version 400-V.A.2.2 in design project file 660. FIG. 7C shows metadata 675-V.A.2.2 associated with Version 400-V.A.2.2 in accordance with an embodiment. Metadata 675-V.A.2.2 is discussed below.

Version manager 310 also updates development history tree 830 (shown in FIG. 8) to include Version 400-V.A.2.1 and Version 400-V.A.2.2. Version 400-V.A.2.1 and Version 400-V.A.2.2 are both located at the Root-A+1 level of development history tree 830.

Suppose now that on a particular date, DATE-2, seven employees of Client XYZ access content versioning system 130 to review the two alternative versions and to select a version that will be used as the basis for the next phase (Phase B) of the project. The seven employees of Client XYZ—Person 1, Person 2, Person 3, Person 4, Person 5, Person 6, and Person 7—employ one or more of stakeholder devices 170-A, 170-B, and 170-C to access content versioning system 130 via network 105. Version manager 310 enables the seven employees of Client XYZ to view the alternative versions 400-V.A.2.1 and 400-V.A.2.2.

At step 920, a plurality of votes relating to the plurality of versions are received from a plurality of parties. In the illustrative embodiment, version manager 310 allows each of the employees of Client XYZ to review and submit a “YES” or “NO” vote for each one of the two alternative versions. Accordingly, each of the seven employees of Client XYZ submits a vote for each of the two versions. In the illustrative example, version 400-V.A.2.2 receives six YES votes and one NO vote, while version 400-V.A.2.1 receives five YES votes and two NO votes.

At step 930, a version of the object is selected from among the plurality of versions, based on the plurality of votes. Because version 400-V.A.2.2 received the highest number of YES votes, version 400-V.A.2.2 wins and is selected as the winning version. Version 400-V.A.2.2 is designated as the version of the design that will proceed to Phase B of the project. Version 400-V.A.2.1 is rejected. In other embodiments, other methods may be used to determine a winning version. For example, in one embodiment, different individuals' votes may be weighted differently. In another embodiment, various organizations (e.g., the design team, the client, etc.) may be defined, and each organization may cast a single vote.

In other embodiments, the process of determining a winning version may include input from persons other than those discussed above. In one embodiment, votes or other types of input may be received from members of the public (using crowd-sourcing techniques, for example). In another embodiment, one or more individuals associated with a government regulatory agency may provide a vote or other type of input.

At step 940, one or more versions of the object are generated based on the selected version. As discussed below, because version 400-V.A.2.2 was ratified to proceed to the phase B, version 400-V.A.2.2 becomes the “root” version of a second development history tree and will be the basis for several alternative versions that will be created during Phase B of the process. These subsequent alternative versions are discussed below.

At step 950, metadata associated with the selected version is stored, the metadata comprising first data specifying the plurality of parties from whom votes were received and second data specifying the votes received. In the illustrative embodiment, version manager 310 updates the metadata corresponding to version 400-V.A.2.1 and the metadata corresponding to version 400-V.A.2.2 to reflect the results of the voting. Information concerning the voting may be automatically generated and stored or manually generated and stored. In addition, the metadata associated with version 400-V.A.2.2 is further updated to indicate that it was the winning design at the end of Phase A.

FIG. 7B shows metadata 675-V.A.2.1 after it is updated to reflect the results of the voting in accordance with an embodiment. The metadata shown in FIG. 7B is illustrative only. In other embodiments, other types of metadata may be stored in association with a version of an object.

Record 701-B holds a version identifier for Version 400-V.A.2.1. Record 702-B holds a timestamp specifying a date and time when the version was fixed. In this instance, Version 400-V.A.2.1 was fixed on TIME-2.1. Record 703-B specifies a location of version 400-V.A.2.1 in the corresponding development history tree. In this instance, record 703-B indicates that version 400-V.A.2.1 is located at level ROOT-A+1 level of development history tree 830. Record 704-B indicates that the version name provided by the users is “Second Draft—Multiple Windows.” Record 705-B stores names of users who contributed to the current fixed version. In this instance, User A, User B, User C, and User D contributed to Version 400-V.A.2.1. Record 706-B holds contact information for the persons specified in record 705-B. Record 707-B stores information defining one or more elements of the design of the current version. In the illustrative embodiment of FIG. 7B, record 707-B indicates that Version 400-V.A.2.1 includes a door, a window, a roof, and a roof window. Record 708-B indicates one or more users who contributed to the design of each element specified in record 707-B. In this example, User C designed the door and User D designed the window. Record 709-B holds comments made by the contributors, if any. In the example of FIG. 7B, no comments are included. Record 710-B may hold comments by other persons, if any. In this example, no other comments are included.

Record 711-B stores information indicating when a conference call was held to discuss the current version. Record 712-B stores information identifying the participants on the conference call. In the illustrative example of FIG. 7B, a conference call to discuss Version 400-V.A.2.1 was held at DATE CC-2.1. User B and User C participated in the conference call. In one embodiment, the metadata in records 711-B and 712-B is automatically generated.

Records 713-B and 714-B indicate, respectively, that a vote relating to the current version was conducted on DATE-2, that five persons voted “YES” and that two persons voted “NO.” Record 715-B indicates that Person 1, Person 2, Person 3, Person 4, Person 5, Person 6, and Person 7 voted. Record 716-B indicates that version 400-V.A.2.1 lost the vote. Record 717-B indicates that Person 1 voted YES, Person 2 voted YES, Person 3 voted YES, Person 4 voted YES, Person 5 voted YES, Person 6 voted NO, and Person 7 voted NO. In one embodiment, the metadata in records 713-B, 714-B, 715-B, 716-B, and 717-B, concerning the voting, may be manually entered by users after the voting is conducted.

Record 718-B holds information specifying a client decision concerning the current version. In the illustrative embodiment, record 718-B indicates that the design was rejected. The information in record 718-B may be automatically generated or manually entered.

Record 719-B stores a cost estimate for the fixed version. In the illustrative embodiment, record 719-B indicates that the estimated cost of Version 400-V.A.2.1 is COST-2.1. Record 720-B may hold information relating to strengths and/or weaknesses of the current fixed version. In the instant example, record 720-B indicates that the current version has “Lots of Windows.” Record 721-B stores information specifying an estimated cost of one or more of the elements listed in record 707-B. In this example, record 721-B indicates that estimated cost of the door would be COST-2.1A, that the estimated cost of the primary windows would be COST-2.1B, and that the estimated cost of the roof window would be 2.1C. Record 722-B stores comments relating to one or more of the elements specified in record 707-B, if any.

Record 723-B specifies that the previous version is Version 400-V.A.1. Record 724-B specifies that User A and User B contributed to the previous version. Record 725-B specifies that the previous version included a door and a window. Record 726-B indicates that User A designed the door and that User B designed the window of the previous version. Record 727-B indicates that the estimated cost of the previous version is COST-1.

FIG. 7C shows metadata 675-V.A.2.2 after it is updated to reflect the results of the voting in accordance with an embodiment. The metadata shown in FIG. 7C is illustrative only. In other embodiments, other types of metadata may be stored in association with a version of an object.

Record 701-C holds a version identifier for Version 400-V.A.2.2. Record 702-C holds a timestamp specifying a date and time when the version was fixed. In this instance, Version 400-V.A.2.2 was fixed on TIME-2.2. Record 703-C specifies a location of version 400-V.A.2.2 in the corresponding development history tree. In this instance, record 703-C indicates that version 400-V.A.2.2 located at level ROOT-A+1 level of development history tree 830. Record 704-C indicates that the version name provided by the users is “Third Draft—Window & Roof” Record 705-C stores names of users who contributed to the current fixed version. In this instance, User B and User C contributed to Version 400-V.A.2.2. Record 706-C holds contact information for the persons specified in record 705-C. Record 707-C stores information defining one or more elements of the design of the current version. In the illustrative embodiment of FIG. 7C, record 707-C indicates that Version 400-V.A.2.2 includes a door, a window, and a roof. Record 708-C indicates one or more users who contributed to the design of one or more of the elements specified in record 707-C. In this example, User B designed the door and User C designed the window. Record 709-C holds comments made by the contributors, if any. In the example of FIG. 7C, no comments are included. Record 710-C may hold comments by other persons, if any. In this example, no other comments are included.

Record 711-C stores information indicating when a conference call was held to discuss the current version. Record 712-C stores information identifying the participants on the conference call. In the illustrative example of FIG. 7C, a conference call to discuss Version 400-V.A.2.2 was held at DATE CC-2.2. User B and User C participated in the conference call.

Records 713-C and 714-C indicate, respectively, that a vote relating to the current version was conducted on DATE-2, and that six persons voted “YES” and that one persons voted “NO.” Record 715-C indicates that Person 1, Person 2, Person 3, Person 4, Person 5, Person 6, and Person 7 voted. Record 716-C indicates that the current version won the vote. Record 717-C indicates that Person 1 voted YES, Person 2 voted YES, Person 3 voted YES, Person 4 voted YES, Person 5 voted YES, Person 6 voted YES, and Person 7 voted NO.

Record 718-C holds information specifying a client decision concerning the current version. In the illustrative embodiment, record 718-C indicates that the design was ratified to proceed to the next phase of design.

Record 719-C stores a cost estimate for the fixed version. In the illustrative embodiment, record 719-C indicates that the estimated cost of Version 400-V.A.2.2 is COST-2.2. Record 720-C may hold information relating to strengths and/or weaknesses of the current fixed version. In the instant example, record 720-C holds the following information: “Nice Door. Has Roof. Needs More Windows.” Record 721-C stores information specifying an estimated cost of one or more of the elements listed in record 707-C. In this example, record 721-C indicates that an estimated cost of the door would be COST-2.2A, that the estimated cost of the windows would be COST-2.2B, and that an estimated cost of the roof would be COST-2.2C. Record 722-C stores comments relating to one or more of the elements specified in record 707-C, if any. In the illustrative example, record 722-C specifies that “Roof is shingles.”

Metadata 675-V.A.2.2 also contains information relating to “ancestor” versions that were created and fixed prior to Version 400-V.A.2.2. In the illustrative embodiment, versions 400-V.A.1 and 400-V.A.2.1 were both fixed prior to Version 400-V.A.2.2. Therefore, information relating to these two prior versions are stored in metadata 675-V.A.2.2.

Record 723-C specifies that a previous version is Version 400-V.A.1. Record 724-C specifies that User A and User B contributed to the previous version. Record 725-C specifies that the previous version included a door and a window. Record 726-C indicates that User A designed the door and that User B designed the window of the previous version. Record 727-C indicates that the estimated cost of the previous version is COST-1.

Record 728-C specifies that another previous version is Version 400-V.A.2.1. Record 729-C specifies that User A, User B, User C, and User D contributed to Version 400-V.A.2.1. Record 730-C specifies that Version 400-V.A.2.1 included a door and a window. Record 731-C indicates that User C designed the window and User D designed the window. Record 732-C indicates that the estimated cost of Version 400-V.A.2.1 is COST-2.1.

Design Company 123 now begins Phase B of the design process. Version 400-V.A.2.2 becomes the “root” version of a second development history tree of alternative versions that will be created during Phase B of the process. Accordingly, version manager 310 creates a copy of Version 400-V.A.2.2 and designates the new root version 400-V.B.1. FIG. 10C shows Version 400-V.B.1 in accordance with an embodiment. Version 400-V.B.1 includes a door 1102, a window 1104, and a roof 1106, which correspond to door 1002, window 1004, and roof 1006 of Version 400-V.A.2.2. Version 400-V.B.1 is stored in a record 654 of design project file 660, as shown in FIG. 6.

Referring to FIG. 6, metadata 675-V.B.1 associated with Version 400-V.B.1 is stored in record 654 of design project file 660. Metadata 675-V.B.1 includes a list of all contributors to Version 400-V.B.1, and also includes information relating to all prior related versions, including Version 400-V.A.2.2, Version 400-V.A.2.1, and Version 400-V.A.1. For example, metadata 675-V.B.1 includes lists of contributors to all prior related versions. In one embodiment, the metadata relating to prior version of Version 400-V.B.1 is automatically generated and added to metadata 675-V.B.1.

Referring to FIG. 8, version manager 310 also generates a second development history tree 840 having Version V.B.1 as its root. Development history tree 840 is also stored development history tree database 800 (shown in FIG. 3).

Subsequently, on DATE-3, User A and User D start from Version 400-V.B.1 and create two alternative versions, Version 400-V.B.2.1 and Version 400-V.B.2.2. Version 400-V.B.2.1 is fixed at TIME-3.1; Version 400-V.B.2.2 is fixed at TIME-3.2. FIG. 10D shows Version 400-V.B.2.1 in accordance with an embodiment. Version 400-V.B.2.1 includes a door 1103, a window 1104, a roof 1106, and a chimney 1108. FIG. 10E shows Version 400-V.B.2.2 in accordance with an embodiment. Version 400-V.B.2.2 includes door 1102, window 1104, roof 1106, and an annex 1115.

Version manager 310 records the new versions in development history tree 840, as shown in FIG. 8. Version manager 310 stores versions V.B.2.1 and V.B.2.2, and associated metadata, in records 655 and 656 of design project file 660, as shown in FIG. 6.

In one embodiment, a development history tree may be used as a tool to navigate among various versions and to view the versions and related metadata. For example, in one embodiment, an individual may view a static display of development history tree 840 and, by clicking on a selected version, the individual may cause the selected version to be displayed. The individual may then right-click on a computer mouse to cause a menu of options to appear. The menu may present options to view different items of metadata associated with the displayed version, for example. By selecting one or more appropriate options, the individual may cause the desired items of metadata to be displayed.

Subsequently, on DATE-4, User C and User D start from Version 400-V.B.2.1 and create three alternative versions, Version 400-V.B.2.1.1, Version 400-V.B.2.1.2, and Version 400-V.B.2.1.3. FIG. 10F shows Version 400-V.B.2.1.1 in accordance with an embodiment. Version 400-V.B.2.1.1 includes a door 1103, window 1104, a roof 1122, and a chimney 1124. FIG. 10G shows Version 400-V.B.2.1.2 in accordance with an embodiment. Version 400-V.B.2.1.2 includes door 1103, a window 1104, roof 1106, a first chimney 1108 and a second chimney 1109. FIG. 10H shows Version 400-V.B.2.1.3 in accordance with an embodiment. Version 400-V.B.2.1.3 includes door 1103, window 1104, a second window 1134, a third window 1135, roof 1106, and a chimney 1108.

Version manager 310 records the new versions in development history tree 840, as shown in FIG. 8. Version manager 310 stores versions V.B.2.1.1, V.B.2.1.2, and V.B.2.1.3, and associated metadata, in records 657-659 of design project file 660, as shown in FIG. 6.

On DATE-5, User A and User B start from Version 400-V.B.2.2, creating Version 400-V.B.2.2.1. FIG. 10I shows Version 400-V.B.2.2.1 in accordance with an embodiment. Version 400-V.B.2.2.1 includes door 1102, window 1104, roof 1106, annex 1115, and annex door 1119.

Version manager 310 records the new version in development history tree 840, as shown in FIG. 8. Version manager 310 also stores version 400-V.B.2.2.1, and associated metadata, in record 681 of design project file 660, as shown in FIG. 6.

Subsequently, Design Company 123 presents the four alternative versions (Versions V.B.2.1.1, V.B.2.1.2, V.B.2.1.3, and V.B.2.2.1) to members of Client ABC.

The members of Client ABC do not feel satisfied with any of the alternative versions of the design. Design Company 123 then presents an animation which presents the root design V.B.1 and the subsequent design history from the root design to each of the alternative designs that derived from root design V.B.1.

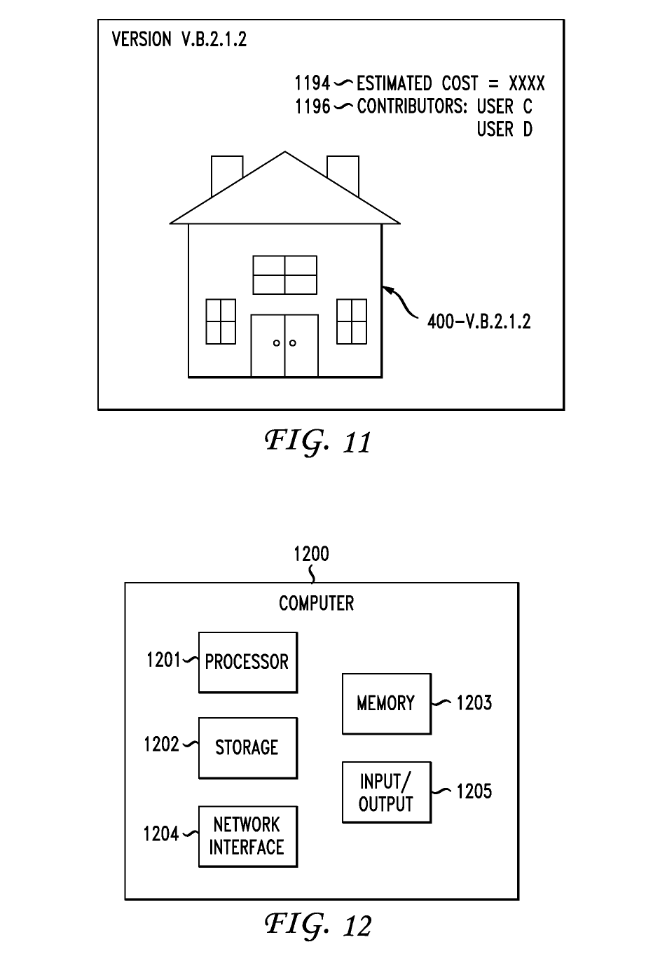

In one embodiment, version manager 310 causes the animation to be displayed on one or more stakeholder devices 170 to enable the members of Client ABC to view the animation. The animation may present the “history” of each “leaf” in the development history tree as an animation, in which a new version is added on top of the version immediately preceding it in the development history tree. Accordingly, the animation may show the chronological development of the versions in the development history tree. For example, the animation may begin by tracing the history of Version V.B.2.1.1 by showing Version 400-V.B.1, and then Version V.B.2.1, and then Version V.B.2.1.1. The animation may then trace the history of Version 400-V.B.2.1.2 by showing Version 400-V.B.1, and then Version V.B.2.1, and then Version V.B.2.1.2. The animation may then show the history of Versions 400-V.B.2.1.3 and Version V.B.2.2.1 in a similar manner. As each version is displayed, selected items of metadata may be displayed as well, such as estimated cost, persons who contributed to the design, strengths and weaknesses, etc. FIG. 11 shows a display of Version 400-V.B.2.1.2 during the animation in accordance with an embodiment. The design of Version V.B.2.1.2 (shown in FIG. 10G) is displayed, for example on a computer display device. Selected items of metadata 1194 indicating an estimated cost of building the design is also displayed. In addition, selected items of metadata 1196 indicating persons who contributed to the design (in this example, User C and User D) is displayed. Other items of metadata may be displayed during the animation.

Presenting the history of each “leaf” facilitates discussion of the direction taken by various branches of the development history tree. In one embodiment, the animation may be stopped at any point, and metadata may be added to a currently displayed version. For example, comments by viewers concerning the advantages and disadvantages of the version may be added. In addition, a numerical score, or other type of score, may be added in the metadata. The animation may also present some or all of the metadata for each version. For example, the animation may display the estimated cost of each version displayed, thereby showing how the estimated cost evolved as the various versions were developed.

The animation of the development history tree(s) can be used for a variety of purposes. The animation may be used to navigate to any one version and examine it. The animation may allow users and clients to see how a selected item of metadata (such as the estimated cost) evolves through the design process from one version to another. The animation allows the various versions to be displayed either in a “forward” sequence or in reverse. The animation may also allow users and clients to see how different members of the design team participated in the design process.

Returning to the illustrative example, after viewing the animation, the members of Client ABC state that they liked the direction the design process was taking when it evolved from Version 400-V.B.1 to Version 400-V.B.2.1, but that they do not like any of the subsequent elaborations. Client ABC also introduces new constraints on the height of the building that will need to be considered during the design process. Because Client ABC liked Version 400-V.B.2.1, this version becomes the root version of a new development tree.

Design Company 123 now begins Phase C of the design process. Version 400-V.B.2.1 becomes the “root” version of a third development history tree of alternative versions that will be created during Phase C of the process. Accordingly, version manager 310 creates a copy of Version 400-V.B.2.1 and designates the new root version 400-V.C.1. FIG. 10J shows Version 400-V.C.1 in accordance with an embodiment. Version 400-V.C.1 includes a door 1203, a window 1204, a roof 1206, and a chimney 1208, which correspond to door 1103, window 1104, roof 1106, and chimney 1108 of Version 400-V.B.2.1. Version 400-V.C.1 is stored in record 682 of design project file 660, as shown in FIG. 6.

Referring to FIG. 6, metadata 675-V.C.1 associated with Version 400-V.B.1 is stored in record 682 of design project file 660. Metadata 675-V.C.1 includes a list of all contributors to Version 400-V.C.1, and also includes information relating to all prior related versions. For example, an automatically generated list of all prior “ancestor” versions, and all contributors to each of the prior versions, is included in the metadata for Version 400-V.C.1.

Referring to FIG. 8, version manager 310 also generates a third development history tree 850 having Version V.C.1 as its root. Development history tree 850 is stored in development history tree database 800 (shown in FIG. 3).

Subsequently, on DATE-6, User B and User C start from Version 400-V.C.1 and create two alternative versions, Version 400-V.C.2.1 and Version 400-V.C.2.2. FIG. 10K shows Version 400-V.C.2.1 in accordance with an embodiment. Version 400-V.C.2.1 includes door 1203, three windows 1301, 1302, and 1303, a roof 1306, and a chimney 1308. FIG. 10L shows Version 400-V.C.2.2 in accordance with an embodiment. Version 400-V.C.2.2 includes a first door 1416, a second door 1417, a first window 1421, a second window 1422, a roof 1406, and a chimney 1408.

Version manager 310 records the new versions in development history tree 850, as shown in FIG. 8. Version manager 310 stores versions V.C.2.1 and V.C.2.2, and associated metadata, in records 683 and 684 of design project file 660, as shown in FIG. 6.

On DATE-7, Client ABC reviews the alternate versions and votes to determine the final design. As a result of the voting, version manager 310 ratifies Version V.C.2.1 as the final design. Version manager 310 updates the metadata associated with Version V.C.2.1 to reflect the voting and the final decision. For example, the metadata for Version 400-V.C.2.1 may include manually entered information specifying the persons who voted, the results of the voting, etc. A star 892 shown in FIG. 8 indicates that Version 400-V.C.2.1 is the final design.

In various embodiments, the method steps described herein, including the method steps described in FIG. 5 and/or 9, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 5 and/or 9. Certain steps of the methods described herein, including one or more of the steps of FIG. 5 and/or 9, may be performed by a server or by another processor in a network-based cloud-computing system. Certain steps of the methods described herein, including one or more of the steps of FIG. 5 and/or 9, may be performed by a client computer in a network-based cloud computing system. The steps of the methods described herein, including one or more of the steps of FIG. 5 and/or 9, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 5 and/or 9, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 12. Computer 1200 comprises a processor 1201 operatively coupled to a data storage device 1202 and a memory 1203. Processor 1201 controls the overall operation of computer 1200 by executing computer program instructions that define such operations. The computer program instructions may be stored in data storage device 1202, or other computer readable medium, and loaded into memory 1203 when execution of the computer program instructions is desired. Thus, the method steps of FIG. 5 and/or 9 can be defined by the computer program instructions stored in memory 1203 and/or data storage device 1202 and controlled by the processor 1201 executing the computer program instructions. For example, the computer program instructions can be implemented as computer executable code programmed by one skilled in the art to perform an algorithm defined by the method steps of FIG. 5 and/or 9. Accordingly, by executing the computer program instructions, the processor 1201 executes an algorithm defined by the method steps of FIG. 5 and/or 9. Computer 1200 also includes one or more network interfaces 1204 for communicating with other devices via a network. Computer 1200 also includes one or more input/output devices 1205 that enable user interaction with computer 1200 (e.g., display, keyboard, mouse, speakers, buttons, etc.).

Processor 1201 may include both general and special purpose microprocessors, and may be the sole processor or one of multiple processors of computer 1200. Processor 1201 may comprise one or more central processing units (CPUs), for example. Processor 1201, data storage device 1202, and/or memory 1203 may include, be supplemented by, or incorporated in, one or more application-specific integrated circuits (ASICs) and/or one or more field programmable gate arrays (FPGAs).

Data storage device 1202 and memory 1203 each comprise a tangible non-transitory computer readable storage medium. Data storage device 1202, and memory 1203, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1205 may include peripherals, such as a printer, scanner, display screen, etc. For example, input/output devices 1205 may include a display device such as a cathode ray tube (CRT) or liquid crystal display (LCD) monitor for displaying information to the user, a keyboard, and a pointing device such as a mouse or a trackball by which the user can provide input to computer 1200.

Any or all of the systems and apparatus discussed herein, including content versioning system 130, user device 160, and stakeholder device 170, and components thereof, including web browser 210, display 270, version manager 310, design tool 306, and design project database 335, may be implemented using a computer such as computer 1200.

One skilled in the art will recognize that an implementation of an actual computer or computer system may have other structures and may contain other components as well, and that FIG. 12 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
storing a plurality of versions of an object in a memory;
receiving, from a plurality of parties, a plurality of votes relating to the plurality of versions;
selecting a version of the object from among the plurality of versions, based on the plurality of votes;
generating one or more versions of the object based on the selected version; and
storing metadata associated with the selected version, the metadata comprising first data specifying the plurality of parties from whom votes were received and second data specifying the votes received.

2. The method of claim 1, wherein the object is an architectural design.

3. The method of claim 1, further comprising:
providing access to the plurality of versions via a network; and
receiving the plurality of votes via the network.

4. The method of claim 1, further comprising:
generating a development history tree indicating relationships among the plurality of versions; and
providing an animation showing a chronological development of the plurality of versions based on the development history tree.

5. The method of claim 1, wherein the metadata associated with the selected version further comprises third data specifying a plurality of elements associated with the selected version and fourth data specifying, for each respective element among the plurality of elements, a contributor who contributed to a design of the element.

6. A non-transitory computer readable medium having program instructions stored thereon which, when executed by a processor, cause the processor to perform operations comprising:
storing a plurality of versions of an object in a memory;
receiving, from a plurality of parties, a plurality of votes relating to the plurality of versions;
selecting a version of the object from among the plurality of versions, based on the plurality of votes;
generating one or more versions of the object based on the selected version; and
storing metadata associated with the selected version, the metadata comprising first data specifying the plurality of parties from whom votes were received and second data specifying the votes received.

7. The non-transitory computer readable medium of claim 6, wherein the object is an architectural design.

8. The non-transitory computer readable medium of claim 6, further comprising program instructions stored thereon which, when executed by a processor, cause the processor to perform operations comprising:
providing access to the plurality of versions via a network; and
receiving the plurality of votes via the network.

9. The non-transitory computer readable medium of claim 6, further comprising program instructions stored thereon which, when executed by a processor, cause the processor to perform operations comprising:
generating a development history tree indicating relationships among the plurality of versions; and
providing an animation showing a chronological development of the plurality of versions based on the development history tree.

10. The non-transitory computer readable medium of claim 6, wherein the metadata associated with the selected version further comprises third data specifying a plurality of elements associated with the selected version and fourth data specifying, for each respective element among the plurality of elements, a contributor who contributed to a design of the element.

11. A method comprising:
storing a plurality of versions of an object, each respective version of the object comprising a plurality of elements;
storing metadata associated with each respective version among the plurality of versions, wherein the metadata associated with a respective version comprises:
first data specifying a plurality of parties who contributed to the version and, for each respective first element associated with the version, a first party who contributed to a creation of the first element; and
second data specifying a second version from which the version was derived, a second plurality of parties who contributed to the second version and, for each respective second element associated with the second version, a second party who contributed to a creation of the second element.

12. The method of claim 11, wherein the object is an architectural design.

13. The method of claim 11, further comprising:
automatically generating first metadata associated with a particular version; and
determining second metadata associated with the particular version based on input received from a user.

14. The method of claim 13, further comprising:
providing access to the plurality of versions via a network; and
receiving the input via the network.

15. The method of claim 14, wherein the input comprises one of: a cost estimate, a comment, and a name of a party who contributed to a creation of a particular element of the particular version.

16. The method of claim 11, wherein the metadata associated with the respective version further comprises:
modifiable metadata that may be modified after being stored; and
fixed metadata that may not be modified after being stored.

17. A non-transitory computer readable medium having program instructions stored thereon which, when executed by a processor, cause the processor to perform operations comprising:
storing a plurality of versions of an object, each respective version of the object comprising a plurality of elements;
storing metadata associated with each respective version among the plurality of versions, wherein the metadata associated with a respective version comprises:
first data specifying a plurality of parties who contributed to the version and, for each respective first element associated with the version, a first party who contributed to a creation of the first element; and
second data specifying a second version from which the version was derived, a second plurality of parties who contributed to the second version and, for each respective second element associated with the second version, a second party who contributed to a creation of the second element.

18. The non-transitory computer readable medium of claim 17, wherein the object is an architectural design.

19. The non-transitory computer readable medium of claim 17, further comprising program instructions stored thereon which, when executed by a processor, cause the processor to perform operations comprising:
automatically generating first metadata associated with a particular version; and
determining second metadata associated with the particular version based on input received from a user.

20. The non-transitory computer readable medium of claim 19, further comprising program instructions stored thereon which, when executed by a processor, cause the processor to perform operations comprising:
providing access to the plurality of versions via a network; and
receiving the input via the network.

21. The non-transitory computer readable medium of claim 20, wherein the input comprises one of: a cost estimate, a comment, and a name of a party who contributed to a creation of a particular element of the particular version.

22. The non-transitory computer readable medium of claim 17, wherein the metadata associated with the respective version further comprises:
modifiable metadata that may be modified after being stored; and
fixed metadata that may not be modified after being stored.

23. An apparatus comprising:
a memory storing computer program instructions; and
a processor communicatively coupled to the memory, the processor configured to execute the computer program instructions which, when executed on the processor, cause the processor to perform operations comprising:
store a plurality of versions of an object in the memory;
receive, from a plurality of parties, a plurality of votes relating to the plurality of versions;
select a version of the object from among the plurality of versions, based on the plurality of votes;
generate one or more versions of the object based on the selected version; and
store metadata associated with the selected version, the metadata comprising first data specifying the plurality of parties from whom votes were received and second data specifying the votes received.

24. The apparatus of claim 23, wherein the object is an architectural design.

25. The apparatus of claim 23, wherein the computer program instructions, when executed on the processor, cause the processor to perform operations comprising:
generating a development history tree indicating relationships among the plurality of versions; and
providing an animation showing a chronological development of the plurality of versions based on the development history tree.

26. The apparatus of claim 23, wherein the metadata associated with the selected version further comprises third data specifying a plurality of elements associated with the selected version and fourth data specifying, for each respective element among the plurality of elements, a contributor who contributed to a design of the element.
